(19) United States
(12) Patent Application Publication
(10) Pub. No.: US 2026/0193007 A1
(43) Pub. Date: Jul. 9, 2026

(54) SEALED SINGLE-DOSE PACKAGE WITH LASER INCISION AND RELATED PRODUCTION METHOD

(71) Applicant: EASYSNAP TECHNOLOGY S.R.L., Castellazzo Bormida (Alessandria) (IT)

(72) Inventors: Andrea TAGLINI, Castellazzo Bormida (Alessandria) (IT); Tomas DI GIROLAMO, Castellazzo Bormida (Alessandria) (IT); Domenico Antonio FLORIO, Castellazzo Bormida (Alessandria) (IT)

(21) Appl. No.: 19/129,406

(22) PCT Filed: Nov. 15, 2023
(86) PCT No.: PCT/IB2023/061544

§ 371 Date: May 13, 2025

(30) Foreign Application Priority Data
Dec. 12, 2022 (IT) 102022000025356

(51) Int. Cl. B65D 75/36; B32B 3/26; B32B 15/085; B32B 15/20; B32B 27/10; B32B 27/32; B65B 5/02; B65B 61/02; B65D 75/58

(52) U.S. Cl. CPC B65D 75/366; B32B 3/263; B32B 15/085; B32B 15/20; B32B 27/10; B32B 27/32; B65B 5/02; B65B 61/02; B65D 75/585; B32B 2250/03; B32B 2311/24; B32B 2439/80; B65D 2221/00; B65D 2575/367

(57) ABSTRACT

A sealed single-dose package with break opening has a multilayer semi-rigid sheet having a carrier layer, an inner layer and a metal barrier layer interposed between the carrier layer and the inner layer, a flexible sheet overlapped and welded to the semi-rigid sheet to form an inner pocket for a product, an outer incision concerning only the carrier layer, and an inner incision concerning only the inner layer. The inner incision is a laser incision. The laser is a CO₂ laser allowing incision of organic materials. A beam of the CO₂ laser encountering the metal barrier layer is reflected towards the inner layer.

The present invention relates to the field of packaging and in particular to the field of sealed single-dose packages with break opening of the “one hand opening” type, i.e. which may be opened by bending the package with one hand.

Such packages, due to their unquestionable convenience of use, have experienced considerable popularity. Currently several hundred million packages of this type are sold every year in many industries, for example for food products, such as sauces and other condiments, and pharmaceutical products, such as eye drops, and dermatological creams, soaps and sanitizers.

Given the profound change in the attitudes of consumers towards the issues of sustainability and environmental protection, the problem of the correct disposal of used packaging is now particularly felt. Since such packages are mostly composed of plastic films, the consumer is now particularly discerning in purchasing.

In addition, to ensure an adequate barrier to gases and vapors, such packages have complex multilayer structures, characterized by the presence of elastic layers that tend to stretch rather than break when the package is folded, so much so that in some cases they cannot be opened properly.

The object of the present invention is to provide a sealed single-dose package with break opening which meets the needs of the field and at the same time overcomes the aforementioned drawbacks.

In particular, it is the object of the present invention to make a predominantly paper-, paperboard-, or cellulose-based package that provides an adequate gas and vapor barrier while maintaining optimal break opening performance.

Such an object is achieved by a sealed single-dose package with break opening according to claim 1 and by a production method according to claim 6. The dependent claims disclose further advantageous embodiments of the invention.

The features and advantages of the package according to the present invention will appear more clearly from the following description, given by way of non-limiting example with reference to the drawings of the accompanying figures, in which:

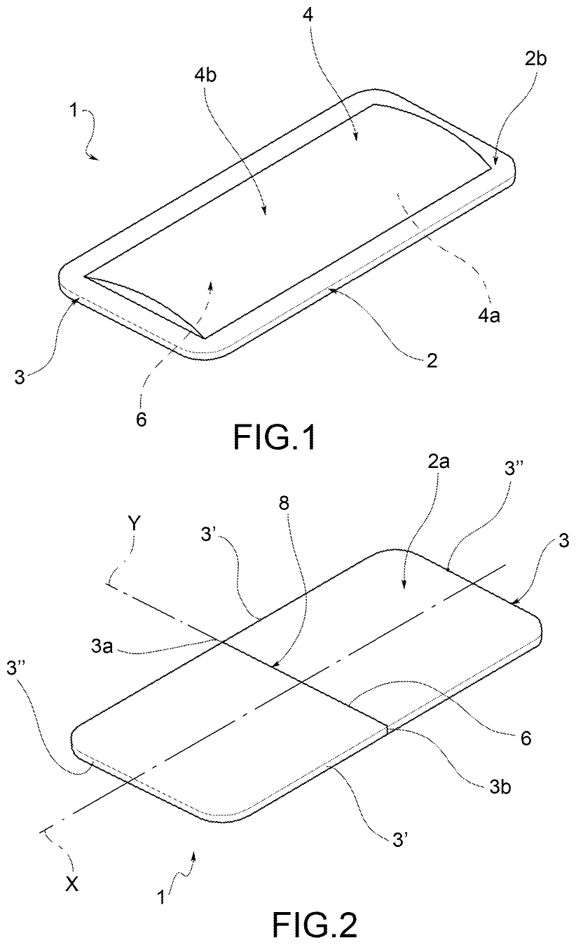

FIG. 1 shows a sealed single-dose package according to an embodiment of the present invention, shown from the front side;

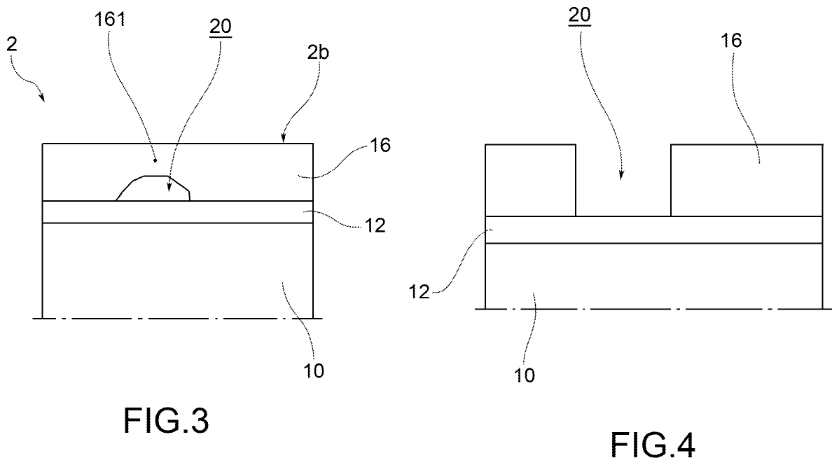

FIG. 2 shows the package of FIG. 1, shown from the rear side;

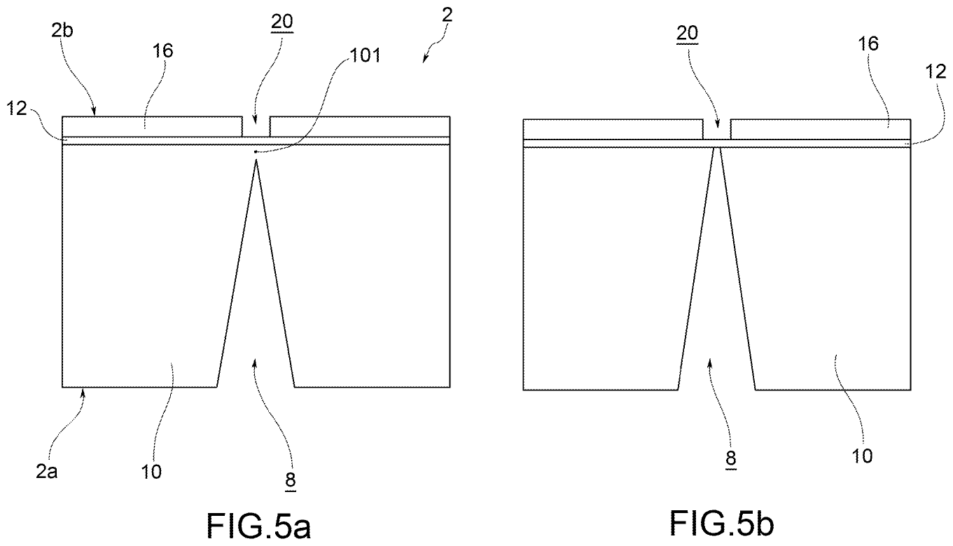

FIG. 3 shows a partial incision of the inner layer of the multilayer structure of the semi-rigid sheet;

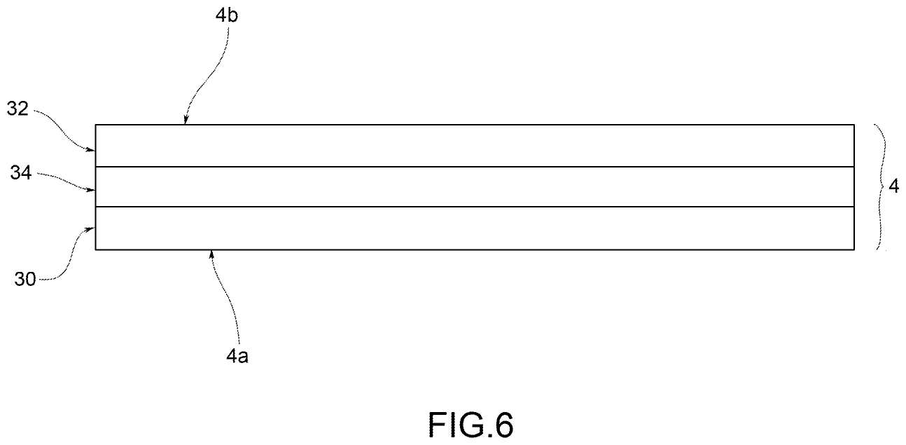

FIG. 4 shows a complete incision of the inner layer of the multilayer structure of the semi-rigid sheet;

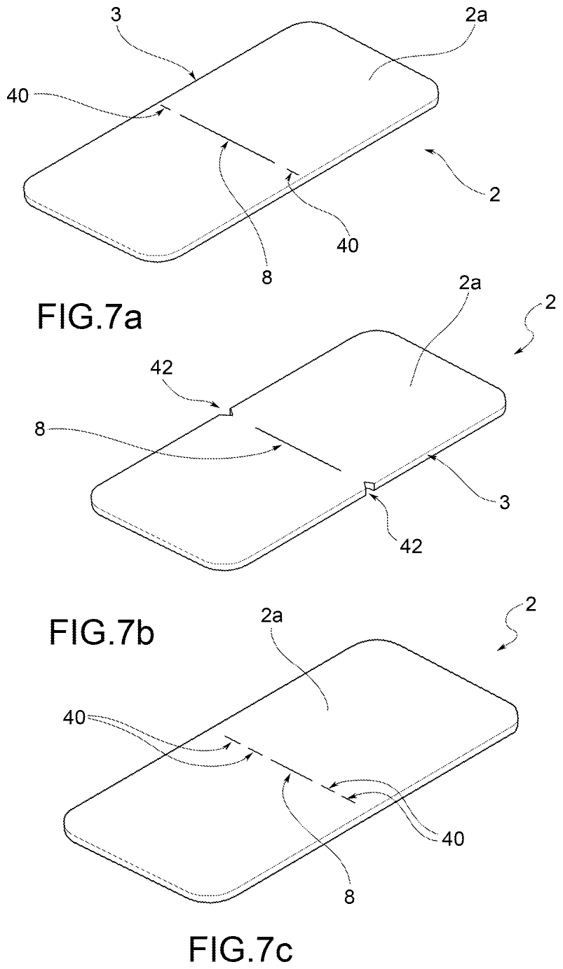

FIG. 5a shows the semi-rigid sheet of the package, pre-weakened, in an exemplary embodiment;

FIG. 5b shows the semi-rigid sheet of the package, pre-weakened, in a further exemplary embodiment;

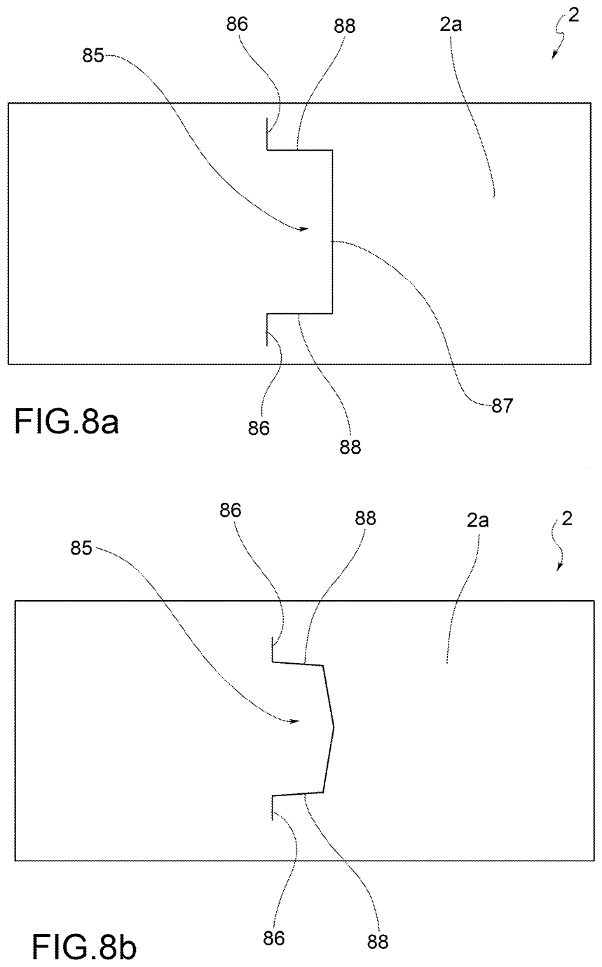

FIG. 6 shows the multilayer structure of the flexible sheet, in an exemplary embodiment;

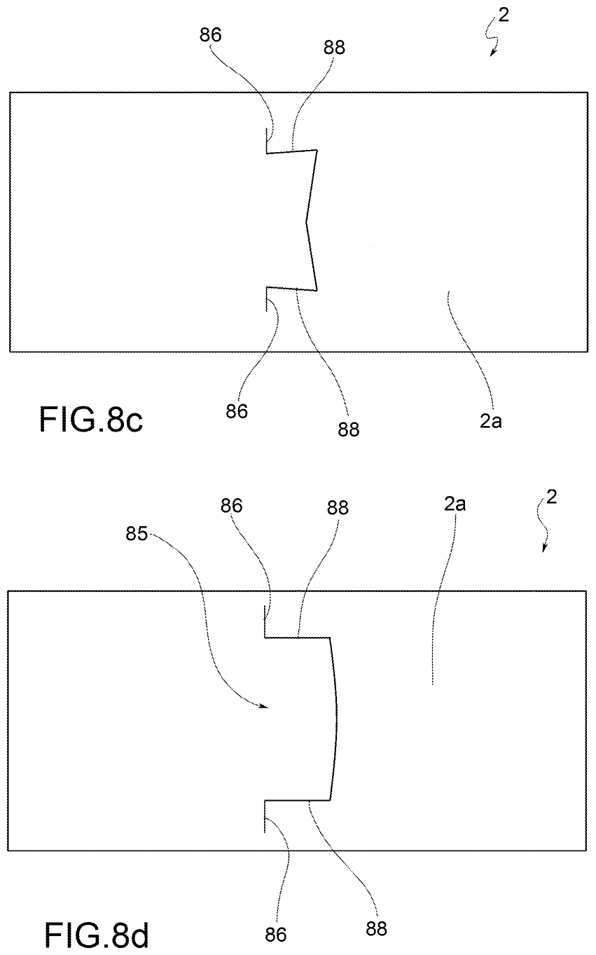

FIGS. 7a to 7c show further embodiments of the semi-rigid sheet according to the invention;

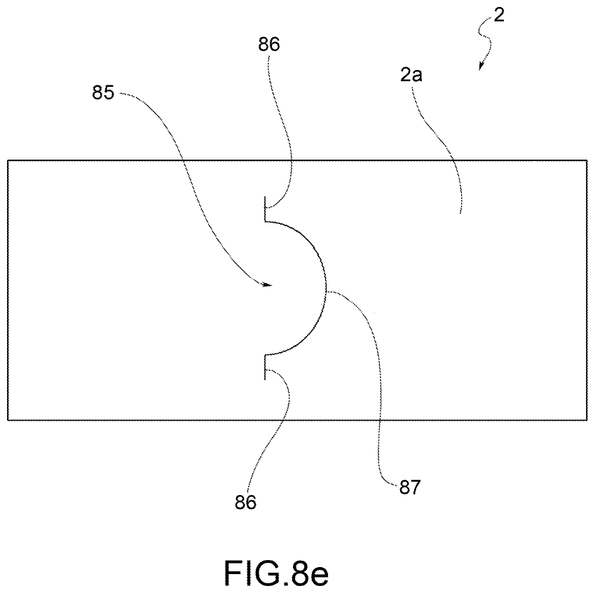

FIGS. 8a to 8e are exemplary embodiments of the external incision.

With reference to the figures of the accompanying tables, reference numeral 1 denotes a sealed single-dose package with break opening. The package 1 comprises a semi-rigid sheet 2, delimited by a peripheral edge 3 and having a rear face 2a and an opposite front face 2b, and a flexible sheet 4, having an inner face 4a and an outer face 4b.

The flexible sheet 4 overlaps the semi-rigid sheet 2, so that the inner face 4a faces the front face 2b, and is welded thereto, so as to form an inner pocket 6 for containing one dose of a product, generally liquid, creamy or powdered.

For example, according to an embodiment, the semi-rigid sheet 2 has a rectangular shape and has opposite long sides 3′ and opposite short sides 3″. The semi-rigid sheet 2 runs along a longitudinal axis X parallel to the long sides 3′.

The semi-rigid sheet 2, which, for example, has an overall thickness of between 300-700 microns, is a multi-layer laminate comprising a carrier layer 10 having said rear face 2a.

The carrier layer 10 is made of paper, cardboard or another mainly cellulose-based material (i.e. cellulose-based for at least 50% by weight). The function of the carrier layer 10 is to impart the necessary texture and stiffness to the package 1. Further, the paper carrier layer 10 gives the feature of printability to the package 1. For example, the carrier layer 10 has a thickness of 250-650 microns, with a weight per unit area of 250-550 g/m2.

Preferably, internally, the semi-rigid sheet 2 comprises a barrier layer 12 suitable for providing a barrier against the passage of gas, and in particular against the passage of oxygen and/or the passage of water vapor. The barrier layer 12 is made of metal. For example, the barrier layer 12 is made of aluminum.

Further, the semi-rigid sheet 2 comprises an inner layer 16 having said front face 2b. The inner layer 16 comprises polyethylene or polypropylene or another material that is suitable for being welded to the flexible film 4. The inner layer 16, in addition to its function of welding with the flexible film 4, is suitable for food contact.

As seen in FIGS. 3 and 4, the barrier layer 12 is interposed between the carrier layer 10 and the inner layer 16.

The flexible sheet 4 is also a multilayer laminate, the structure of which is shown in FIG. 6.

The flexible sheet 4 comprises an inner layer 30 having said inner face 4a. The inner layer 30 comprises polyethylene or polypropylene or a sealing lacquer or other material suitable for being welded to the semi-rigid film 2.

Externally, the flexible sheet 4 comprises an outer layer 32 having said outer face 4b. The outer layer 32 comprises paper, cardboard, or another, predominantly cellulose-based, material.

Furthermore, the flexible sheet 4 preferably comprises an intermediate layer 34 placed between the inner layer 30 and the outer layer 32. For example, the intermediate layer 34 has barrier £ properties and comprises aluminum or EVOH, and/or has binding properties with the inner layer 30 and with the outer layer 32.

According to an embodiment variant, the flexible sheet 4 has no intermediate layer 34 and the inner layer 30 is directly in contact with the outer layer 32.

Overall, the package 1 provides that the paper, cardboard or other mainly cellulose-based material of the semi-rigid sheet and the paper, cardboard or other mainly cellulose-based material of the flexible sheet together constitute at least 50%, preferably at least 60% by weight of the entire (empty) package.

On the rear face 2a of the semi-rigid sheet 2, at the pocket 6, there is an outer incision 8 which extends along an incision direction Y, for example transversal, that is, in the aforementioned embodiment, along a direction incident to the longitudinal axis X, preferably orthogonal thereto.

For example, the outer incision 8 joins two opposite points 3a, 3b of the peripheral edge 3; in the aforementioned embodiment, this means that it extends over the entire width of the rectangular semi-rigid sheet.

The outer incision 8 extends only through the carrier layer 10 of the semi-rigid sheet 2.

Preferably, the outer incision 8 has a depth, measured from the front face 2a, that is typically constant along the outer incision 8.

In another exemplary embodiment, the outer incision 8 has a depth, measured from the front face 2a, that typically varies transversely along the outer incision 8. For example, the depth is greatest in a central segment of the incision 8. Advantageously, this variation in depth along the incision ensures the break opening in a controlled manner, preventing the break from being sudden and therefore preventing the product from being projected outwards in a damaging manner.

In the exemplary embodiment in FIG. 5a, the maximum depth of the outer incision 8 is less than the total thickness of the carrier layer 10. That is to say, the outer incision 8 does not reach the barrier layer 12, as a residual portion 101 remains interposed between the outer incision 8 and the barrier layer 12.

In the exemplary embodiment in FIG. 5b, the maximum depth of the outer incision 8 is equal to the total thickness of the carrier layer 10. That is to say, the outer incision 8 reaches the barrier layer 12 but does not affect it. In such an example, therefore, the barrier layer 12 is exposed.

The inner layer 16 is elastic and tends to stretch rather than break, so much so that it risks compromising the proper opening by folding until the package breaks. Therefore, the inner layer 16 also has an incision, defined as the inner incision 20, which at least partially interrupts the inner layer 16.

On the front face 2b of the semi-rigid sheet 2, at the pocket 6, there is an inner incision 20 that runs along an incision direction Y, e.g., transverse, i.e., in the aforesaid embodiment, along a direction incident to the longitudinal axis X, preferably orthogonal thereto.

Preferably, the inner incision 20 is aligned, that is, completely overlapping, with the outer incision 8, as shown in FIGS. 5a and 5b.

The inner incision 20 affects only the inner layer 16, without affecting the barrier layer 12.

Preferably, the inner incision 20 of the inner layer 16 develops starting from the side in contact with the barrier layer 12.

In the exemplary embodiment in FIG. 4, the inner incision 20 completely interrupts the inner layer 16, leaving the barrier layer 12 exposed. Such a solution ensures optimal weakening of the elastic layers, ensuring the proper opening by folding to break open the package, while keeping the barrier properties of the package 1 intact.

In the exemplary embodiment in FIG. 3, the inner incision 20 only partially interrupts the inner layer 16. Specifically, the inner incision 20 is confined on the side in contact with the barrier layer 12. In such an exemplary embodiment, a residual portion 161 of the inner layer 16 overlaps the inner incision 20. The residual portion 161 of the inner layer 16 is small enough to break when folding the package, but still such that the contact between the barrier layer 12 and the product contained in the package 1 is prevented. In this way, the barrier layer 12 always remains covered by the inner layer 16, and in particular the residual portion 161, and never in contact with the product contained in the package 1.

According to an embodiment variant, the inner incision 20 and/or the outer incision 8 have a longitudinal section of a substantially triangular shape, tapered towards the inside of the sheet; according to further embodiments, the longitudinal section is substantially rectangular.

The inner incision 20 of the inner layer 16 is an incision obtained by laser. Preferably, the laser used is a CO2 laser, which allows the incision of organic materials and not metals. Therefore, when the CO2 laser beam meets the metal barrier layer 12, it is reflected without affecting it. Advantageously, by striking the front face 2b of the semi-rigid sheet 2, it is possible to partially or completely incise the inner layer 16 without affecting the barrier layer 12.

Preferably, the inner incision 20 of the inner layer 16 develops starting from the side in contact with the barrier layer 12. By virtue of the reflection of the CO2 laser beam on the barrier layer 12, the inner incision 20 will propagate in the inner layer 16 starting from the barrier layer 12, as in FIG. 3.

Advantageously, the use of a CO2 laser cutter to make the inner incision 20 makes it possible to ensure 100% integrity of the barrier layer 12.

Either a laser cut or a mechanical cut may be used to make the outer incision 8. Preferably, the outer incision 8 is made before the inner incision 20 in order to further ensure the integrity of the barrier layer 12.

The function of the outer incision 8 is to ensure the folding of the semi-rigid sheet 2 and the breaking of the outer layer 10.

The function of the inner incision 20 is to ensure the breakage of the inner layer 16 and the metal barrier layer 12, which will break under the thrust of the product allowing the package 1 to be opened properly.
FIGS. 7a to 4c show further embodiments of the semi-rigid sheet according to the invention.

According to an embodiment (FIGS. 7a and 7c), the semi-rigid sheet 2 has, on the rear face 2a, at least one weakened portion 40 that is separate from and preferably aligned with the outer incision 8, to facilitate the folding of the package.

A weakened portion 40 is an additional incision in the carrier layer 10 that is shorter in length with respect to the outer incision 8. The weakened portion 40 has an equal or shallower depth than the outer incision 8. Note that the weakened portion 40 is not aligned, even partially, with the inner incision 20, to prevent the creation of additional openings for the product to escape in addition to the opening made through the outer incision 8. Preferably, the outer incision 8 is arranged centrally and the weakened portions 40 are arranged on the sides.

For example, there are two weakened portions 40, one on each side of the outer incision 8, symmetrical with respect to the outer incision 8, near the peripheral edge 3(FIG. 7a).

For example, there are multiple weakened portions on each side of the outer incision 8, symmetrical with respect to the outer incision 8 (FIG. 7c).

According to an embodiment (FIG. 7b), the semi-rigid sheet 2 has at least one recess 42 made along the peripheral edge 3, separate from and preferably aligned with the outer incision 8, to facilitate the folding of the package. For example, two recesses 42 are provided, symmetrical with respect to the outer incision 8. Preferably, the recesses 42 are triangular, with the vertex turned towards the outer incision 8.

According to an embodiment, the outer incision 8 does not join two points of the peripheral edge 3, but is interrupted, or it starts from a point on the peripheral edge 3 and is interrupted before reaching the other point of the peripheral edge 3.

According to an embodiment (FIGS. 8a to 8e), the outer incision 8 runs along a broken line 85.

Preferably, this broken line 85 comprises: two end segments 86, aligned with each other and each arranged close to the peripheral edge 3 and transversely thereto; preferably also a pair of transverse segments 88, substantially orthogonal to the end segments 86; and a center line 87.

In the example in FIG. 8a, the center line 87 is straight.

In the example in FIGS. 8b and 8c, the center line 87 is in turn a broken line.

In the example in FIGS. 8d and 8e, the center line 87 is a curved line.

In the examples in FIGS. 8a to 8d, the broken line 85 comprises two end segments 86, two transverse segments 88 and a center line 87.

In the example in FIG. 8e, the broken line 85 comprises two end segments 86 and a center line 87.

The subject-matter of the present invention also refers to a method for producing a single-dose sealed package 1 with break opening. This method involves:
preparing a semi-rigid sheet 2 having a rear face 2a and an opposite front face 2b; the semi-rigid sheet 2 is a multilayer comprising:
   a carrier layer 10 with the rear face 2a;
   an inner layer 16 with the front face 2b;
   a metal barrier layer 12 interposed between the carrier layer 10 and the barrier layer 12;
making an outer incision 8 on the rear face 2a of the semi-rigid sheet 2, at the pocket 6, which only involves the carrier layer 10;
using a CO2 laser to make an inner incision 20 on the front face 2b of the semi-rigid sheet 2, at the pocket 6, affecting only the inner layer 16; this step involves at least partially incising the inner layer 16 without affecting the barrier layer 12;
overlapping a flexible sheet 4, with an inner face 4a and an outer face 4b, on the semi-rigid sheet 2, so that the inner face 4a is facing the front face 2b;
welding said flexible sheet 4 to the front face 2b so as to form the inner pocket 6 for containing one dose of a product.

Note that the CO2 laser beam does not affect the barrier layer 12 but is reflected by said barrier layer 12 towards the inner layer 16. Preferably, the inner incision 20 runs into the inner layer 16 from a side in contact with the barrier layer 12.

Preferably, the outer incision 8 is made before the inner incision 20.

Innovatively, the package according to the present invention overcomes the drawbacks mentioned with reference to the prior art, since it allows for a package with a very low environmental impact, and in particular recyclable with paper, and a high barrier to gas and vapors, while maintaining optimal break opening performance.

It is clear that those skilled in the art may make changes to the package and the manufacturing method described above in order to meet incidental needs, which changes all falling within the scope of protection defined in the following claims.

1-9. (canceled)

10. A sealed single-dose package with break opening, comprising:
a semi-rigid sheet comprising a rear face and an opposite front face, the semi-rigid sheet being a multilayer comprising:
a carrier layer having the rear face;
an inner layer having the front face, the inner layer comprising polyethylene or polypropylene;
a metal barrier layer interposed between the carrier layer and the inner layer, the metal barrier layer being made of aluminum;
a flexible sheet comprising an inner face and an outer face, overlapped on the semi-rigid sheet so that the inner face faces the front face, and welded to the front face to form an inner pocket for containing one dose of a product;
an outer incision on the rear face of the semi-rigid sheet, at the inner pocket, which only involves the carrier layer; and
an inner incision on the front face of the semi-rigid sheet, at the inner pocket, which only involves the inner layer, the inner incision being a laser incision,
wherein the carrier layer is made of paper, cardboard or other predominantly cellulose-based material, and
wherein the inner incision only partially interrupts the inner layer, and the metal barrier layer remains covered by a residual portion of the inner layer.

11. The sealed single-dose package of claim 10, wherein the flexible sheet comprises:
an inner layer having the inner face, the inner layer comprising polyethylene or polypropylene; and
an outer layer having the outer face, the outer layer comprising paper, cardboard, or other predominantly cellulose-based material.

12. The sealed single-dose package of claim 11, wherein the flexible sheet further comprises an intermediate layer placed between the inner layer and the outer layer, the intermediate layer having barrier properties and comprising aluminum or ethylene vinyl alcohol (EVOH).

13. The sealed single-dose package of claim 10, wherein the outer incision has a depth, measured from the rear face, that varies transversely along the outer incision.

14. The sealed single-dose package of claim 13, wherein the depth is greatest in a central segment of the outer incision.

15. The sealed single-dose package of claim 10, wherein the outer incision does not reach the metal barrier layer and a residual portion of the carrier layer remains interposed between the outer incision and the metal barrier layer.

16. A method for manufacturing a sealed single-dose package with break opening, the method comprising:
providing a semi-rigid sheet comprising a rear face and an opposite front face, the semi-rigid sheet being a multilayer comprising:
a carrier layer having the rear face, the carrier layer being made of paper, cardboard or other predominantly cellulose-based material;
an inner layer having the front face, the inner layer comprising polyethylene or polypropylene; and
a metal barrier layer interposed between the carrier layer and the inner layer, the metal barrier layer being made of aluminum;
at an inner pocket, making an outer incision on the rear face of the semi-rigid sheet, the outer incision only involving the carrier layer;
at the inner pocket and aligned with the outer incision, making an inner incision, by a CO₂ laser, on the front face of the semi-rigid sheet, the inner incision only involving the inner layer; and
overlapping a flexible sheet comprising an inner face and an outer face on the semi-rigid sheet so that the inner face faces the front face, and welding the flexible sheet to the front face to form the inner pocket for containing one dose of a product,
wherein making the inner incision by the CO₂ laser includes at least partially incising the inner layer without incising the metal barrier layer, and
wherein the inner incision only partially interrupts the inner layer, and the metal barrier layer remains covered by a residual portion of the inner layer.

17. The method of claim 16, wherein a beam of the CO₂ laser does not incise the metal barrier layer but is reflected by the metal barrier layer towards the inner layer.

18. The method of claim 16, wherein the inner incision runs into the inner layer from a side in contact with the metal barrier layer.

19. The method of claim 16, wherein the outer incision is made prior to the inner incision.
